(19) United States
(12) Patent Application Publication
(10) Pub. No.: US 2010/0067601 A1
(43) Pub. Date: Mar. 18, 2010

(54) REDUCTION OF OVERHEAD IN A MULTIPLE-INPUT MULTIPLE-OUTPUT (MIMO) SYSTEM

(76) Inventors: Joshua Lawrence Koslov, Hopewell, NJ (US); Wen Gao, West Windsor, NJ (US); Yik-Chung Wu, Sheung Shui (HK)

Correspondence Address: Robert D. Shedd, Patent Operations;THOMSON Licensing LLC, P.O. Box 5312, Princeton, NJ, 08543-5312, US

(21) Appl. No.: 12/312,765

(22) PCT Filed: Dec. 6, 2006
(86) PCT No.: PCT/US2006/046653

§ 371 Date: May 26, 2009

(51) Int. Cl. H04L 1/02; H04W 72/00

(52) U.S. Cl. 375/267; 370/329

(57) ABSTRACT

A multi-access multiple-input multiple-output (MIMO) system comprises a base station (BS) and a number of user equipment (UE), N, for serving N users. The BS divides the N users into L mobility groups, where each mobility group is associated with a certain range of channel dynamics. Those mobility groups having lower channel dynamics—that is, the channel dynamics change less rapidly—are updated with beamforming information less frequently than those mobility groups having higher dynamics—that is, the channel dynamics change more rapidly.

### BACKGROUND OF THE INVENTION

The present invention generally relates to communications systems and, more particularly, to multiple-input multiple-output (MIMO) systems.

A multi-access MIMO system is a wireless system in which the wireless endpoints have multiple antennas. An example of such a system is a base station (BS) with multiple transmitting/receiving antennas communicating with a plurality of user equipment (UE), each UE having multiple transmitting/receiving antennas. A benefit of using multiple antennas is that the spectral efficiency of the whole system can be significantly increased through spatial multiplexing. For example, several UEs can transmit data to the BS at the same-time, with the same frequency, and the BS can still discriminate the data from each UE.

In a multi-access MIMO system, the overall capacity of the system can be further improved if there is channel state information available at the transmitter (CSIT). For example, if a BS has access to channel state information associated with each UE, the BS can use this channel state information to select particular UEs to transmit. One known technique for selecting UEs to transmit uses the instantaneous channel signal-to-noise (SNR) ratio as representative of the channel state information. In a multi-access MIMO system, an indicator of the instantaneous channel SNR between a BS and a particular UE is the “channel realization”, which is measured in terms of the Frobenius norm of the channel state matrix. In this context, if the multi-access MIMO system has N users (each user having an associated UE), the BS selects those k users to be “on” whose channel realization exceeds a particular threshold, where k≦N.

In addition, beamforming information can be used in a multi-access MIMO system to improve communications in a particular direction. For example, the BS can feedback beamforming information to each UE in order to improve the upstream (UE to BS) performance. In order to use the feedback bits more efficiently, a vector quantization (VQ) technique has been proposed where the beamforming information from the BS to multiple “on” users are combined and then sent simultaneously.

### SUMMARY OF THE INVENTION

We have observed that in a multi-access MIMO system the creation of beamforming information for transmission to multiple users does not take into account differences in mobility among the user population. For example, certain users may exhibit fairly static channel characteristics—i.e., they may not be moving—whereas other users may exhibit dynamic channel characteristics—i.e., they may be moving rapidly. As a result, all beamforming information to all UE is updated and transmitted at a rate dictated by the most dynamic channels. Unfortunately, this leads to an increase in overall transmission overhead for the system. Therefore, and in accordance with the principles of the invention, control information (e.g., beamforming information) is transmitted to a wireless endpoint as a function of mobility of the wireless endpoint. Thus, the overall transmission overhead used for control information can be appreciably reduced by taking into account the mobility of the users.

In an illustrative embodiment of the invention, a multi-access MIMO system comprises a BS, a number of UE, N, for serving N users and the control information is beamforming information. The BS divides the N users into L mobility groups, where each mobility group is associated with different levels of mobility. Illustratively, levels of mobility are associated with different ranges of channel dynamics. Those mobility groups having lower channel dynamics—that is, the channel dynamics change less rapidly—are updated with beamforming information less frequently than those mobility groups having higher dynamics—that is, the channel dynamics change more rapidly. In this way, the overall downlink transmission overhead used for beamforming can be appreciably reduced by taking into account the mobility of the users.

In another illustrative embodiment of the invention, a multi-user MIMO system comprises a BS, a number of UE, N, for serving N users and the control information is beamforming information. The BS divides the N users into L mobility groups, where each mobility group is associated with different levels of mobility. Illustratively, the levels of mobility include at least a stationary level and at least one moving level, where each UE is assigned a priori to one of the levels of mobility. Any UE assigned to the stationary mobility group are updated with beamforming information less frequently than those UE assigned to the at least one moving level.

In view of the above, and as will be apparent from reading the detailed description, other embodiments and features are also possible and fall within the principles of the invention.

### BRIEF DESCRIPTION OF THE DRAWINGS

FIG. 1 shows an illustrative multi-access MIMO system in accordance with the principles of the invention;

FIG. 2 shows an illustrative wireless endpoint for use in the multi-access MEMO system of FIG. 1 in accordance with the principles of the invention;

FIG. 3 shows an illustrative flow chart for use in the multi-access MIMO system of FIG. 1 in accordance with the principles of the invention;

FIG. 4 shows an illustrative message flow for use in the multi-access MIMO system of FIG. 1.

FIG. 5 illustrates scheduling intervals for sending control information for use in the flow chart of FIG. 3;

FIG. 6 shows another illustrative flow chart for use in the multi-access MIMO system of FIG. 1;

FIG. 7 illustrates scheduling intervals for use in the flow chart of FIG. 6; and

FIGS. 8 and 9 show illustrative message flows for use in the multi-access MIMO system of FIG. 1.

### DETAILED DESCRIPTION

Other than the inventive concept, the elements shown in the figures are well known and will not be described in detail. Also, familiarity with multiple-input multiple-output (MIMO) systems is assumed and is not described in detail herein. For example, other than the inventive concept, a channel state matrix, the determination of a Frobenius norm from the channel state matrix and a vector quantization (VQ) beamforming is known and not described herein. Likewise, other than the inventive concept, wireless transmission concepts such as orthogonal frequency division multiplexing (OFDM) or orthogonal frequency division multiple access (OFDMA), and receiver components such as a radio-frequency (RF) front-end, or receiver section, such as a low noise block, tuners, and demodulators, correlators, leak integrators and squarers is assumed and not described herein. Similarly, other than the inventive concept, familiarity with formatting and encoding methods (such as Moving Picture Expert Group (MPEG)-2 Systems Standard (ISO/IEC 13818-1)) for generating transport bit streams and networking techniques such as IEEE 802.16, 802.11h, etc., is assumed and not described herein. It should also be noted that the inventive concept may be implemented using conventional programming techniques, which, as such, will not be described herein. Finally, like-numbers on the figures represent similar elements.

As noted above, in a multi-access MIMO system, communications in a particular direction can be improved by the use of beamforming information. As known in the art, beamforming is a signal processing technique used with arrays of transmitters or receivers that controls the directionality of, or sensitivity to, a radiation pattern. For example, the BS can feedback beamforming information to each UE in order to improve the upstream (UE to BS) performance. In order to use the feedback bits more efficiently, a vector quantization (VQ) technique has been proposed where the beamforming information from the BS to Multiple “on” users are combined and then sent simultaneously. However, we have observed that in a multi-access MIMO system the creation of beamforming information for transmission to multiple users does not take into account differences in mobility among the user population. For example, certain users may exhibit fairly static channel characteristics—i.e., they may not be moving—whereas other users may exhibit dynamic channel characteristics—i.e., they may be moving rapidly. As a result, all beamforming information to all UE is updated and transmitted at a rate dictated by the most dynamic channels. Unfortunately, this leads to an increase in overall transmission overhead for the system. Therefore, and in accordance with the principles of the invention, control information (e.g., beamforming information) is transmitted to a wireless endpoint as a function of mobility of the wireless endpoint. Thus, the overall transmission overhead used for control information can be appreciably reduced by taking into account the mobility of the users.

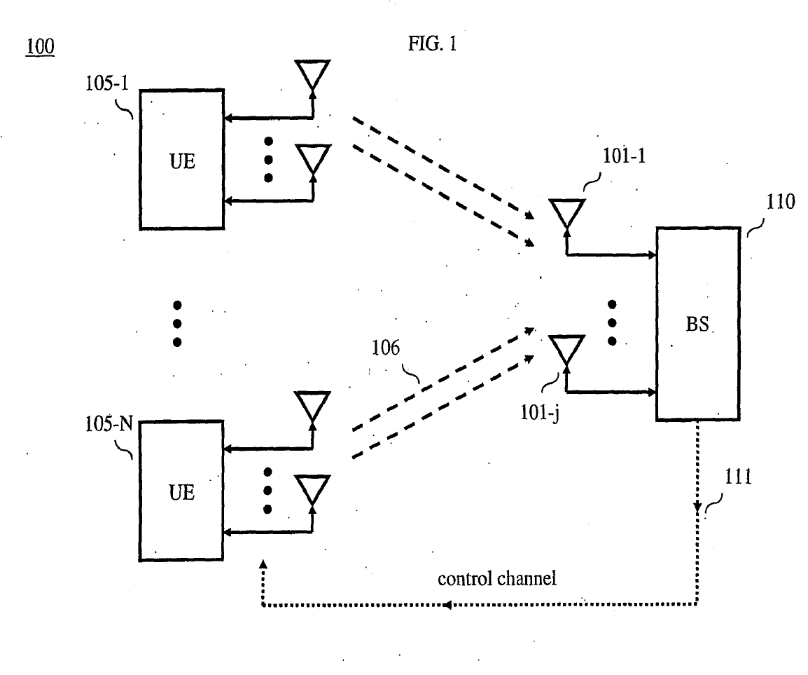

An illustrative multi-access MIMO system 100 (hereafter simply system 100) in accordance with the principles of the invention is shown in FIG. 1. System 100 comprises a base station (BS) 110 and a plurality of user equipment (UE) as represented by UE 105-1 through 105-N. BS 110, UE 105-1 and UE 105-N represent wireless endpoints and, as such, system 100 is a wireless communications system. Each UE may be stationary or mobile. For the purposes of this description it is assumed that each UE is associated with a user, i.e., system 100 has N users. However, the invention is not so limited and each UE can be associated with more than one user and/or one user can be associated with more than one UE. As shown in FIG. 1, each wireless endpoint has multiple antennas used for transmitting and receiving. This is illustrated for BS 110, which has j antennas, 101-1 through. 101-j, where j>1. As such, in the uplink direction BS 110 receives multiple signals from each UE as represented in dashed arrow form (e.g., see arrows 106 associated with the uplink channel between UE 105-N and BS 110). For simplicity, corresponding communications in the downlink direction from BS 110 to a UE is not shown in FIG. 1 other than downlink control channel 111. The later communicates control information from BS 110 to each UE. Downlink control channel 111 is also referred to herein as a feedback channel or feedback link. It should be noted that, other than the inventive concept, the use of a feedback channel in an MIMO system is well-known and, as such, not described herein. For the purposes of this description, it is assumed that channel information about the uplink channel is provided from BS 110 to each UE via downlink control channel 111. In this context, since BS 110 terminates the uplink channel, it is assumed that BS 110 has full knowledge about the uplink channel and provides channel state information about the uplink channel to each UE via downlink control channel 111. In practice, since the channel state information is likely to be carried within some control field (not shown) of downlink control channel 111, the amount of channel information that can be conveyed to each UE is rate limited and, as such, it is assumed that each UE receives at least partial channel information about the respective uplink channel.

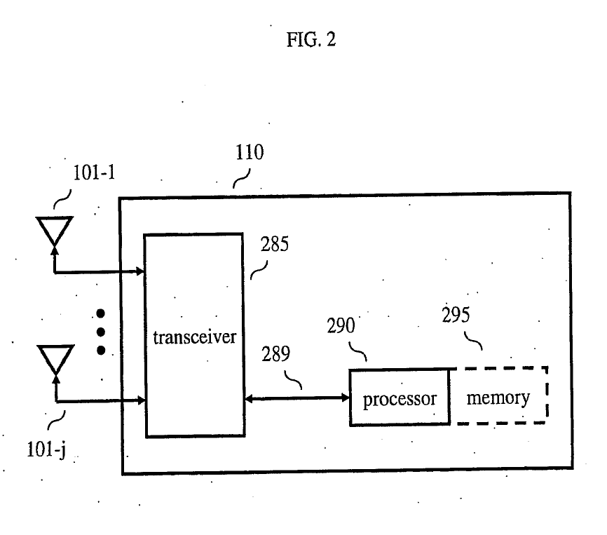

Turning now to FIG. 2, an illustrative portion of a wireless endpoint in accordance with the principles of the invention is shown. Only that portion of the wireless endpoint relevant to the inventive concept is shown. In this example, the wireless endpoint is representative of BS 110. However, the inventive concept is not so limited and applies to any wireless endpoint, e.g., UE 105-1 of FIG. 1, etc. As can be observed from FIG. 2, BS 110 is a processor-based system and includes one, or more, processors and associated memory as represented by processor 290 and memory 295 (the later shown in dashed-line form). In this context, computer programs, or software, are stored in memory 295 for execution by processor 290. The latter is representative of one, or more, stored-program control processors and these do not have to be dedicated to any one particular function, e.g., processor 290 may also control other functions of BS 110 that are not described herein. Memory 295 is representative of any storage device, e.g., random-access memory (RAM), read-only memory (ROM), etc.; may be internal and/or external to processor 290; and is volatile and/or non-volatile as necessary. BS 110 also comprises a plurality of antennas 101-1 through 101-j, and a transceiver section 285. Transceiver section 285 comprises one, or more, transceivers (transmitter-receivers) that are coupled to respective ones of the antennas 101-1 through 101-j for transmitting, and receiving, wireless signals to, and from, the plurality of UE illustrated in FIG. 1. In this context, transceiver section 285 may comprise physically separate transceiver elements or be implemented such that the requisite transceiver function is provided by, e.g., a digital signal processor. Processor 290 controls transceiver section 285 and receives information from transceiver section 285 via signaling path 289. The latter is representative of a signaling/data bus and may include other components for coupling processor 290 with transceiver section 285.

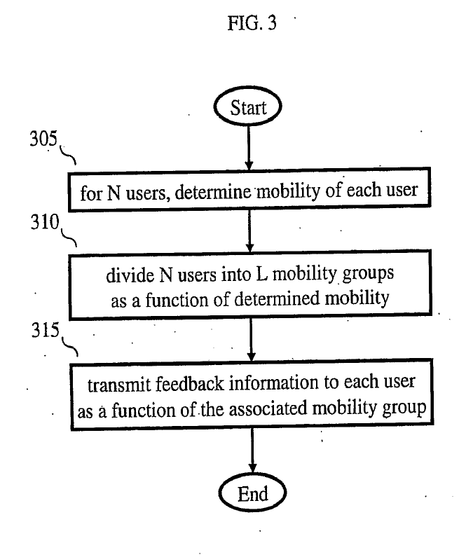

Referring now to FIG. 3, an illustrative flow chart for use in providing control information in accordance with the principles of the invention is shown. In this example, the control information is beamforming information and levels of mobility are associated with different measures of the dynamics of the communications channel (the channel dynamics). Turning in detail now to FIG. 3, it is assumed that there are a total of N users in system 100. In step 305, processor 290 determines the mobility for each user. Illustratively, processor 290 uses the channel state matrix Hₖ for each user as a measure of the channel dynamics for each user. As known in the art, a channel state matrix, H, represents channel vectors from the transmit antennas to the receive antennas and, e.g., dictates the inter-stream interference between the different transmit streams from each transmit antenna. BS 110 can determine the channel state matrix H by estimation using the uplink channel. As such, and in accordance with the principles of the invention, if a UE is moving at high speed (e.g., in a car), then values in the respective channel state matrix Hₖ will change quickly over time—i.e., the user is highly mobile. However, if the UE is moving at a slow speed (e.g., a person walking), then values in the respective channel state matrix Hₖ will change even slower than for a UE moving at high speed. In this case, the user is moderately mobile. Similarly, if the UE is stationary, then values in the respective channel state matrix Hₖ will change even slower than for a UE moving at a slow speed and the values of the channel state matrix Hₖ may even appear static. In this case, the user is considered to be stationary, i.e., not mobile.

Once the mobility of each user is determined, processor 290 then divides, or assigns, each user to one of L mobility groups in step 310, where L≦N. Each mobility group is associated with a certain range of channel dynamics. It should be noted that although steps 305 and 310 are shown as separate steps, the invention is not so limited and these steps may be combined, e.g., as the mobility of a user is determined, the user is assigned to a mobility group.

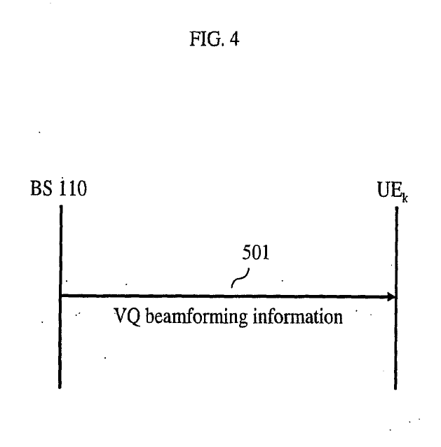

Finally, in step 315, processor 290 controls transceiver 285 to provide VQ beamforming information back to a respective UE as a function of its assigned mobility group via downlink control channel 111. This is illustrated in the message flow diagrams of FIG. 4. When a UE is scheduled to receive control information, BS 110 sends, e.g., VQ beamforming information in message 501 as illustrated in FIG. 4. Illustratively, the rate of providing beamforming information to a particular UE is directly related to the level of mobility of the mobility group, e.g., a UE in a mobility group having a high level of mobility receives beamforming information more often than a UE in a mobility group having a lower level of mobility.

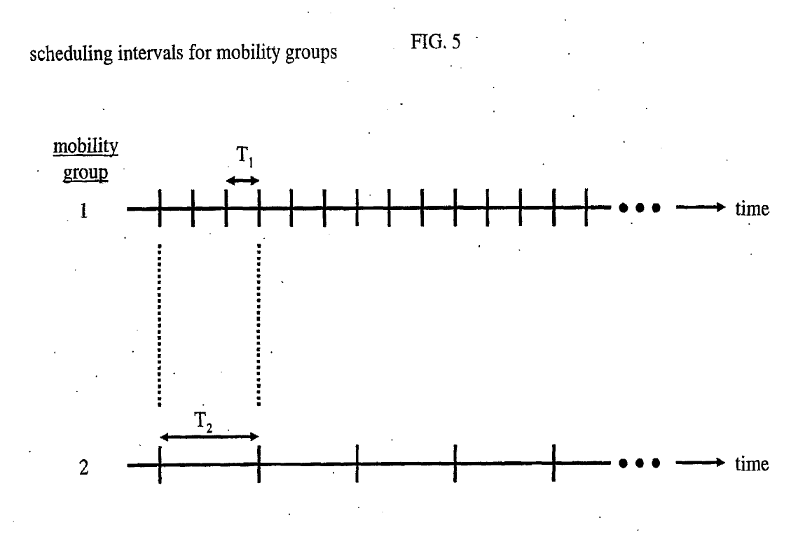

Continuing with the above example, the flow chart of FIG. 3 is illustrated, in the context of L=2 mobility groups, where mobility group 2 is associated with a stationary level, of mobility and mobility group 1 is associated with any level of mobility. In step 305, processor 290 identifies those users whose channel state matrices, Hₖ, do not change over a period of time, i.e., static channel state matrices. In step 310, processor 290 assigns those UE with static channel state matrices to mobility group 2 and all other UE to mobility group 1. In other words, in this example, UE assigned to mobility group 1 are more mobile than those UE assigned to mobility group 2. In step 315, processor 290 controls transceiver 285 to provide VQ beamforming information back to a respective UE as a function of its assigned mobility group. This is illustrated further in the timelines of FIG. 5, which illustrate scheduling intervals for providing control information to UE as a function of the assigned mobility group. Those UE assigned to mobility group 1 receive VQ beamforming information at a rate 1/T₁; while those UE assigned to mobility group 2 receive VQ beamforming information at a rate 1/T₂; where T₂>T₁. As can be observed from FIG. 5, those UE associated with mobility group 1 are scheduled to receive VQ beamforming information three times as frequently as those UE associated with mobility group 2.

It should be noted that the mobility of a user can be determined in any number of ways. For example, the Frobenius norm, which is a function of the channel state matrix, can also be used as a measure of mobility, although this may be less accurate than the above-described use of the channel state matrices, Hₖ. Also, users can be preassigned to different levels of mobility a priori. Illustratively, the levels of mobility include at least a stationary level and at least one moving level. Any UE assigned to the stationary mobility group are updated with beamforming information less frequently than those UE assigned to the at least one moving level. This assignment to a particular mobility group (steps 305 and 310 of FIG. 3) can be based on, e.g., a user specified preference communicated from the UE to the base station at registration; or, e.g., as a function of the type of UE at registration time, e.g., a laptop, cell phone, etc.

Finally, as noted earlier, the overall capacity of a multi-access MIMO system, can be further improved if there is channel state information available at the transmitter (CSIT). For example, if a BS has access to channel state information associated with each UE, the BS can use this channel state information to select particular UEs to transmit. In the context of the inventive concept, any selection technique can be used to select a UE to transmit. For example, one known technique for selecting UEs to transmit uses the instantaneous channel signal-to-noise (SNR) ratio as representive of the channel state information. In a multi-access MIMO system, an indicator of the instantaneous channel SNR between a BS and a particular UE is the “channel realization”, which is measured in terms of the Frobenius norm of the channel state matrix. In this context, if the multi-access MIMO system has N users (each user having an associated UE), the BS selects those k users to be “on” whose channel realization exceeds a particular threshold, where k≦N.

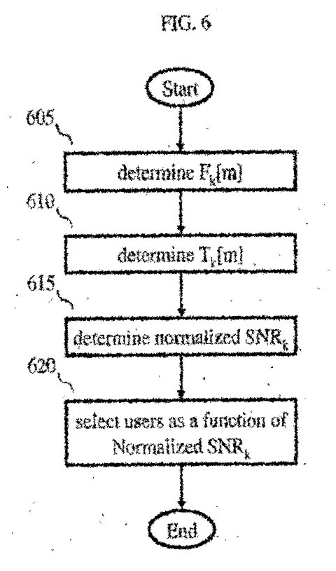

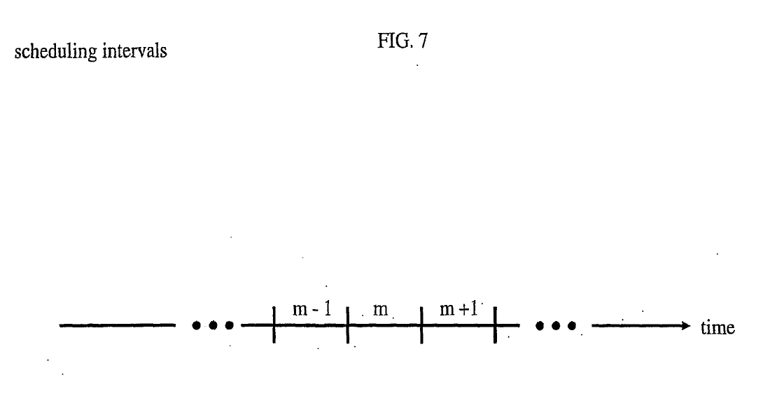

Another method of selecting transmitters is shown if the flow chart of FIG. 6. It is assumed that BS 110 of FIGS. 1 and 2 performs user scheduling in periodic time intervals as illustrated in FIG. 7. Turning in detail now to FIG. 6, it is assumed that there are a total of N users in system 100. In each scheduling (time) interval (e.g., interval m of FIG. 7), processor 290 determines the Frobenius norm of the channel state matrix for each user, k, in step 605, where k ranges from 1 to N. For a particular user, k, the Frobenius norm in a time interval, m, is denoted herein as Fₖ[m]. As noted earlier, determination of the Frobenius norm of a channel state matrix is known and not described herein. Then, in step 610, processor 290 determines for every user, k, the average of Fₖ[m], which is denoted as Tₖ[m]. In particular, Tₖ[m] is updated using the following illustrative exponential weighted low-pass filter

$${T}_{k} [ m + 1 ] = \{ \begin{matrix}( 1 - α ) {T}_{k} [ m ] + α {F}_{k} [ m ] , & when k \text{-} th user is turned on \\ ( 1 - α ) {T}_{k} [ m ] , & otherwise\end{matrix} \qquad ( 1 )$$

In equation (1), the parameter, α, is the weight factor, illustratively, e.g., α=0.1. It should be observed from equation (1) that processor 290 performs different calculations depending on whether or not the k^{th} user is currently turned “on”. As such, it is assumed that processor 290 maintains a table indicating the currently turned “on” users in, e.g., memory 295 (table not shown). Turning now to step 615, processor 290 determines a ratio between the Frobenius norm of the channel state matrix and the average of the Frobenius norm of the channel state matrix for each user, k, in the scheduling interval, m. This ratio is representative of a Normalized SNR, i.e.,

$$Normalized S N {R}_{k} = \frac{{F}_{k} [ m ]}{{T}_{k} [ m ]} . \qquad ( 2 )$$

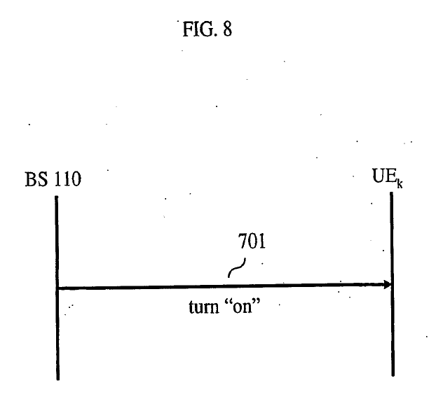

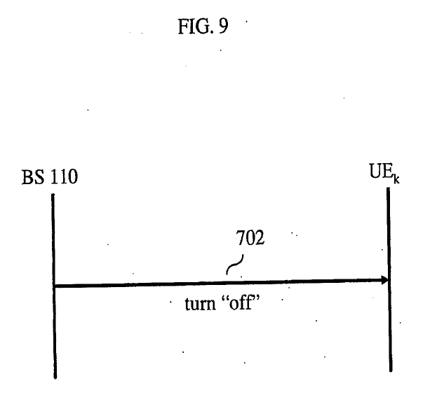

Finally, in step 620, processor 290 selects K users to be turned “on” as a function of the Normalized SNR. For example, BS 110 can select those users whose Normalized SNR exceeds a predetermined threshold. Alternatively, BS 110 can select those K users to be turned on who have larger Normalized SNRₖ values in a scheduling interval, m, than the remaining N-K users, where K>0. The particular value for K can be determined experimentally. As part of, or after, the selection process of step 620, BS 110 sends a message to the respective UE to either turn “on” or “off”. This is illustrated in the message flow diagrams of FIGS. 8 and 9. If a UE is selected to turn “on”, BS 110 sends a turn “on” message 701 as illustrated in FIG. 8. On the other hand, if the UE is not selected to turn “on”, then BS 110 sends a turn “off” message 702 as illustrated in FIG. 9. It should be noted that if a particular UE is not selected to turn “on” and is already turned “off”, then BS 110 may not have to send a turn “off” Message. Likewise, if a particular UE is selected to turn “on” and the UE is already turned “on”, then BS 110 may not have to send a turn “on” message.

Whatever selection process is used, the inventive concept can be easily modified for those systems where only particular UE are turned “on.” For example, for an N-user MIMO system, assume the users are divided into two mobility groups, where the first mobility group comprises N₁ users with high channel dynamics, and the second mobility group comprises (N-N₁) users with low channel dynamics. Assume further that the selection process used by the BS (e.g., the one shown in the flow chart of FIG. 6) turns on l users in the system. For fair scheduling, processor 290 of FIG. 2 turns on

$$⌊ l \frac{{N}_{1}}{N} ⌋$$

users in the first mobility group, and turns on

$$l - ⌊ l \frac{{N}_{1}}{N} ⌋$$

users in the second mobility group.

As a result of the above-described communication process using illustrative beamforming information, the overall transmission overhead used for control information can be appreciably reduced by taking into account the mobility of the users. It should be noted that although the examples above illustrated that the rate of feeding back control information to a wireless endpoint was directly related to the mobility level of the group, the invention is not so limited and, e.g., the rate of feeding back control information can be any function of the mobility level of the group. For example, in some systems it may be determined that those users with lower levels of mobility receive control information more frequently than users with higher levels of mobility. Or, each level of mobility may be assigned different rates of transmission of control information where the different rates of transmission do not directly correspond to a mobility level. For example, consider three mobility groups 1, 2 and 3, where the level of mobility increases from mobility group 1 to mobility group 3, i.e., mobility group 3 is more mobile than mobility group 2, which is more mobile than mobility group 1. However, it may be determined for this system that the rates of feeding back control information are such that mobility group 2 should receive control information more frequently than UE in either of the other two mobility groups. Further, it should be noted that the inventive concept does not require that a mobility group have any UE assigned to it. For example, it may be the case that all UE are assigned to the same mobility group. It should also be noted that although the inventive concept was described in the context of mobility groups, the invention is not so limited and, e.g., the term “mobility group” is equivalent to, e.g., the term “feedback group”, where a feedback group simply associates a rate of transmission of control information to particular wireless endpoints. Finally, it should again be noted that although some of the figures, e.g., the wireless endpoint of FIG. 2, were described in the context of BS 110 of FIG. 1, the invention is not so limited and also applies to, e.g., UE 105-1, which may also operate in accordance with the principles of the invention.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIG. 3, etc. Further, the principles of the invention are not limited to a MIMO system and are applicable to other types of communications systems, e.g., Wireless-Fidelity (Wi-Fi), etc. It is therefore to be understood that numerous modifications may be made to the illustrative embodiments and that other arrangements may be devised without departing from the spirit and scope of the present invention as defined by the appended claims.

1. A method for use in a first wireless endpoint, the method comprising:
assigning a second wireless endpoint to one of a plurality of mobility groups; and
transmitting control information to the second wireless endpoint as a function of the assigned mobility group.

2. The method of claim 1, wherein the assigning step includes the steps of:
determining a mobility of the second wireless endpoint; and
assigning the second wireless endpoint to the one of the plurality of mobility groups as a function of the determined mobility of the second wireless endpoint.

3. The method of claim 2, wherein the determining step includes the step of:
measuring a dynamic of a communications channel between the first wireless endpoint and the second wireless endpoint;
wherein the measured dynamic is representative of the mobility of the second wireless endpoint.

4. The method of claim 3, wherein the measuring step measures a rate of change of a channel state matrix.

5. The method of claim 3, wherein the measuring step measures a rate of change of a Frobenius norm of a channel state matrix.

6. The method of claim 1, wherein each one of the plurality of mobility groups is associated with different rates of transmission.

7. The method of claim 6, wherein each mobility group is associated with a mobility level and wherein a mobility group with a higher level of mobility is associated with a higher rate of transmission than a mobility group with a lower level of mobility.

8. The method of claim 1, wherein the control information is beamforming information.

9. The method of claim 1, wherein the first wireless endpoint is a part of a multiple-input multiple-output (MEMO) system.

10. Apparatus for use in a first wireless endpoint, the apparatus comprising:
a transmitter for sending control information to a second wireless endpoint; and
a processor for assigning the second wireless endpoint to one of a plurality of mobility groups, and for controlling the transmitter such that the control information is sent to the second wireless endpoint as a function of the assigned mobility group.

11. The apparatus of claim 10, wherein the processor determines a mobility of the second wireless endpoint; and assigns the second wireless endpoint to the one of the plurality of mobility groups as a function of the determined mobility of the second wireless endpoint.

12. The apparatus of claim 11, wherein the processor determines the mobility by measuring a dynamic of a communications channel between the first wireless endpoint and the second wireless endpoint, wherein the measured dynamic is representative of the mobility of the second wireless endpoint.

13. The apparatus of claim 12, wherein the processor measures the dynamic of the communications channel by measuring a rate of change of a channel state matrix.

14. The apparatus of claim 12, wherein the processor measures the dynamic of the communications channel by measuring a rate of change of a Frobenius norm of a channel state matrix.

15. The apparatus of claim 10, wherein each one of the plurality of mobility groups is associated with different rates of transmission.

16. The apparatus of claim 10, wherein each mobility group is associated with a mobility level and wherein a mobility group with a higher level of mobility is associated with a higher rate of transmission than a mobility group with a lower level of mobility.

17. The apparatus of claim 10, wherein the control information is beamforming information.

18. The apparatus of claim 10, wherein the first wireless endpoint is a part of a multiple-input multiple-output (MIMO) system.
